(19) United States
(12) Patent Application Publication
(10) Pub. No.: US 2008/0274296 A1
(43) Pub. Date: Nov. 6, 2008

(54) ENERGY-CURABLE COATING/ADHESIVE COMPOSITIONS CONTAINING CHLORINATED POLYOLEFINS

(76) Inventor: Levi F. Scott, Upper Darby, PA (US)

Correspondence Address: FOX ROTHSCHILD LLP, 1101 MARKET STREET, PHILADELPHIA, PA, 19107, US

(21) Appl. No.: 12/173,919

(22) Filed: Jul. 16, 2008

Related U.S. Application Data
(63) Continuation of application No. 11/099,010, filed on Apr. 5, 2005.
(60) Provisional application No. 60/563,383, filed on Apr. 19, 2004.

(51) Int. Cl. B01J 19/08; C08F 265/04; C08F 265/06

(52) U.S. Cl. 427/521; 525/302; 525/242; 525/304

(57) ABSTRACT

Free radical, energy-curable coating compositions comprising: (a) at least one ethylenically-unsaturated monomer component; and (b) at least one chlorinated polyolefin, wherein the at least one chlorinated polyolefin is at least partly soluble in the at least one monomer component; are described along with processes for coating substrates therewith.

### CROSS-REFERENCE TO RELATED APPLICATIONS

This application claims priority, under 35 U.S.C. §119(e), of U.S. Provisional Patent Application No. 60/563,383, filed on Apr. 19, 2004, the entire contents of which are hereby incorporated by reference.

### BACKGROUND OF THE INVENTION

Plastic materials such as thermoplastic olefin (TPO) have been developed which are useful in many applications, such as automobile parts and accessories, containers, household appliances, and other commercial items. It is often desirable to coat articles made from such plastic materials with organic coating compositions to decorate them or to protect the plastic materials from degradation when exposed to atmospheric weathering conditions such as sunlight, moisture, heat and cold. To achieve longer lasting and more durable parts, it is necessary for the coatings to be tightly adhered to the surface of the plastic.

Plastic substrates made from a variety of thermoplastic and thermosetting plastic materials have widely varying surface properties including surface tension, roughness, and flexibility, which make it difficult to achieve adequate adhesion of the organic coatings to such materials, particularly after aging or environmental exposure of the plastic materials. The problems can be particularly difficult in automotive applications where in addition to the requirement that decorative and protective coatings adhere well to the plastic substrate, there are other requirements which are difficult to achieve. In respect to the utilization of thermoplastic polyolefin substrates, these requirements include a high degree of resistance of the finally coated part to organic solvents, particularly gasoline, and a high degree of resistance of any hardened coating to humidity.

A number of proposals have been made for overcoming the adhesion problem ranging from flame or corona pretreatments to the application of various solvent-based primer compositions containing chlorinated polyolefins to the plastic polyolefin substrate. While such techniques have achieved a fair measure of success with respect to the adhesion problem, there remain various disadvantages such that the goal, for example, of achieving a desired combination of excellent adhesion, solvent resistance, particularly to gasoline, and humidity resistance in an advantageously economic manner has remained elusive.

In addition, solvent-based formulations are unfavorable for environmental reasons. Accordingly, solvent-free coating/adhesive formulations based on energy-curable components have become more popular.

Existing energy-cure adhesion technology generally uses acrylic, acidic, or aromatic functional materials to provide adhesion to various substrates. Unfortunately, the adhesion of energy-curable coating formulations to low surface energy substrates is also problematic. While, some chlorinated polyolefins have been identified as being good adhesion promoters in solvent-based applications, their utility becomes limited when they are used in aqueous or polar formulations. Most halogenated polyolefins suffer from solubility issues in polar media. This fact limits their utility when formulated with ethylenically unsaturated compounds found in energy-curable formulations.

Thus, a need exists in the art to provide energy-curable coating formulations which benefit from the lack of environmentally unfriendly solvents, and yet possess excellent adhesion to plastic and other low surface energy substrates.

### BRIEF SUMMARY OF THE INVENTION

The present invention is directed to energy-curable coating formulations having excellent adhesion to low surface energy substrates. More specifically, the present invention is directed to energy-curable coating formulations which comprise an energy-curable monomer, and a chlorinated polyolefin which is at least partly soluble in the monomer. The coating formulations according to the present invention possess excellent wetting characteristics and stable, homogenous formulations. In addition, they do not require environmentally unfriendly solvents. The coating formulations according to the present invention, when cured, provide low surface energy substrate coatings which adhere excellently, provide excellent protection to the substrate and remain flexible.

One embodiment of the present invention includes a coating composition comprising: (a) at least one energy-curable monomer component; and (b) at least one chlorinated polyolefin, wherein the at least one chlorinated polyolefin is at least partly soluble in the at least one monomer component. Another embodiment of the present invention includes a free radical, energy-curable coating composition comprising: (a) at least one ethylenically-unsaturated monomer component; and (b) at least one chlorinated polyolefin, wherein the at least one chlorinated polyolefin is at least partly soluble in the at least one monomer component.

Yet another embodiment of the present invention includes a process for coating a substrates said process comprising: (a) providing a substrate to be coated; (b) providing a free radical, energy-curable coating composition comprising: (i) at least one ethylenically-unsaturated monomer component, and (ii) at least one chlorinated polyolefin, wherein the at least one chlorinated polyolefin is at least partly soluble in the at least one monomer component; (c) applying the coating composition to at least a portion of the substrate; and (d) subjecting the coated substrate to radiant energy.

### DETAILED DESCRIPTION OF THE INVENTION

Other than in the operating examples, or where otherwise indicated, all numbers expressing quantities of ingredients or reaction conditions used herein are to be understood as modified in all instances by the term “about”.

Coating compositions according to the present invention contain at least one ethylenically-unsaturated monomer component. Suitable ethylenically-unsaturated monomer components for use in the compositions according to the present invention include compounds with acrylic, methacrylic, allylic, and vinylic functionalities. Such compounds include acrylates, methacylates, vinyl compounds, homopolymers of such compounds, as well as copolymers, block copolymers, terpolymers and block terpolymers of two or more of such compounds.

In certain preferred embodiments of the present invention, the at least one ethylenically-unsaturated monomer component comprises an acrylate or methacrylate. Suitable (meth)acrylates (i.e., acrylates or the corresponding methacrylate) include, but are not limited to, linear and branched alkyl acrylates such as methyl acrylate, ethyl acrylate, isopropyl acrylate, n-butyl acrylate, isoamyl acrylate, isooctyl acrylate, hydroxyalkylacrylates, butoxyethyl acrylate, nonylphenoxyethyl acrylate, tetrahydrofurfuryl acrylate, N-methyl pyrrolidone acrylate, 2-ethylhexylacrylate, 2-phenoxyethylacrylate, 2(2-ethoxyethoxy)ethyl acrylate, isodecyl acrylate, isobornyl acrylate, diol diacrylates such as 1,6-hexanedioldiacrylate, polyolacrylates and polyglycol acrylates such as propoxylated neopentylglycol monomethyl ether acrylate, triethylene glycol diacrylate, tetraethylene glycol diacrylate, neopentyl glycol diacrylate, pentaerythritol triacrylate, trimethylolpropane triacrylate, and tripropylene glycol diacrylate.

In certain preferred embodiments of the present invention, the acrylate comprises a polyfunctional acrylate. Suitable polyfunctional acrylates include diol diacrylates such as 1,6-hexanedioldiacrylate, polyolacrylates and polyglycol acrylates such as propoxylated neopentylglycol monomethyl ether acrylate, triethylene glycol diacrylate, tetraethylene glycol diacrylate, neopentyl glycol diacrylate, pentaerythritol triacrylate, trimethylolpropane triacrylate, and tripropylene glycol diacrylate. In certain preferred embodiments of the present invention, the polyfunctional acrylate comprises a diacrylate. A preferred diacrylate is 1,6-hexanedioldiacrylate.

In certain preferred embodiments of the present invention wherein the at least one ethylenically-unsaturated monomer component comprises a polyfunctional acrylate, the coating composition further comprises a monofunctional acrylate adhesion promoter. Suitable monofunctional acrylate adhesion promoters include, but are not limited to tetrahydrofurfuryl acrylate, N-methyl pyrrolidone acrylate, 2-phenoxyethyl acrylate, 2(2-ethoxyethoxy)ethyl acrylate, isodecyl acrylate, isobornyl acrylate, propoxylated neopentylglycol monomethyl ether acrylate and mixtures thereof.

Coating compositions according to the present invention also contain at least one chlorinated polyolefin. Generally any chlorinated polyolefin which exhibits at least some solubility in the at least one ethylenically-unsaturated monomer component can be used in the compositions according to the present invention. At least some solubility refers to a degree of solubility that is more Man negligible, for example, at least about 1% by weight based on the weight of the monomer component. In preferred embodiments of the present invention, the at least one chlorinated polyolefin will have a solubility in the at least one monomer component of at least about 5% by weight based on the weight of the monomer component. In a more preferred embodiment of the present invention, the at least one chlorinated polyolefin will have a solubility in the at least one monomer component of at least about 10% by weight based on the weight of the monomer component. In other more preferred embodiments of the present invention, the at least one chlorinated polyolefin will have a solubility in the at least one monomer component of at least about 15% by weight based on the weight of the monomer component. In other more preferred embodiments of the present invention, the at least one chlorinated polyolefin will have a solubility in the at least one monomer component of at least about 20% by weight based on the weight of the monomer component. In the most preferred embodiments of the present invention, the at least one chlorinated polyolefin will have a solubility in the at least one monomer component of at least about 25% by weight based on the weight of the monomer component, and even more preferably at least about 30% by weight.

As used herein, the term “polyolefin” refers to polymers derived from olefins, both mono-olefinically unsaturated and polyunsaturated, and includes, but is not limited to, polyethylene, polypropylene, polybutenes, polyisoprene, as well as homopolymers and copolymers thereof.

Certain preferred chlorinated polyolefins suitable for use in the present invention can be prepared by polymerizing and chlorinating at least one component selected from the group of olefin monomers, polyolefin monomers, conjugated diene monomers, diene block homopolymers and diene block copolymers. II certain other preferred embodiments of the present invention, the at least one chlorinated polyolefin can be prepared by polymerizing and chlorinating at least two components selected from the group consisting of olefin monomers, polyolefin monomers, conjugated diene monomers, diene block homopolymers and diene block copolymers.

In certain more preferred embodiments of the present invention, the at least one chlorinated polyolefin can be prepared by polymerizing and chlorinating a conjugated diene monomer. Preferred conjugated diene monomers include 1,3-butadiene and isoprene. The most preferred conjugated diene monomer is isoprene.

In preferred embodiments of the present invention, the at least one chlorinated polyolefin includes a chlorinated rubber, and more preferably chlorinated polyisoprene.

In certain preferred embodiments of the present invention wherein the at least one chlorinated polyolefin includes a chlorinated rubber, the chlorinated rubber will have a viscosity in toluene at a concentration of 18.5% by weight at room temperature of from about 1 to about 40000 centipoise. The method of measurement can be that according to DIN 53015. More preferably, the viscosity will be between 3 and 10000 centipoise. Even more preferably, the viscosity will be between 5 and 1000 centipoise. Even more preferably, the viscosity will be between 5 and 300 centipoise. Most preferably, the viscosity will be between 5 and 100 centipoise.

The chlorine content of the at least one chlorinated polyolefin of the present invention will generally be from 1 to 75% by weight of the polyolefin. In preferred embodiments of the present invention, the chlorine content will be from 50 to 75% by weight. In more preferred embodiments of the present invention, the chlorine content will be from 60 to 75% by weight. In the most preferred embodiments of the present invention, the chlorine content will be from 65 to 75% by weight.

Chlorinated polyolefins suitable for use in certain preferred embodiments of the present invention includes chlorinated rubbers sold under the tradename PERGUT®, available from Bayer AG. Such chlorinated rubbers include PERGUT® S5, PERGUT® S10, PERGUT® S20, and PERGUT® S40.

The at least one energy-curable monomer component and the at least one chlorinated polyolefin can be combined in any amount in the compositions of the present invention. It is preferable to combine the chlorinated polyolefin and the monomer component in amounts such that the chlorinated polyolefin is present in an amount at or near its solubility limit in the monomer component.

The coating compositions according to the present invention may further contain acrylated oligomer additives, reactive diluents, photoinitiators, surfactants, pigments, additional adhesion promoters, flatting agents, stabilizers and other ordinary additives and auxiliaries.

The present invention also includes processes for coating a substrate. Any substrate can be coated in accordance with the processes of the present invention. In preferred embodiments of the present invention, the substrate will be a low surface energy substrate. Any substrate with a surface energy of 40 dynes per cm or less can be considered “low surface energy” for the purposes of the present invention. The coating compositions according to the present invention can be applied to the substrate by any suitable means. Radiant energy can be supplied to the coating composition on the substrate in the form of ultraviolet radiation or by electron beam bombardment.

The present invention will now be illustrated in more detail by reference to the following specific, non-limiting examples.

### EXAMPLES 1-60

In Examples 1-60, sixty different mixtures of chlorinated polyolefins and energy-curable monomers were prepared and evaluated for solubility. Each of four chlorinated polyolefins (namely PERGUT® S5, PERGUT® S20, Eternal 6314-100 and CP 164-1) were combined in tree different amounts (2, 4 and 10% by weight based on the energy curable monomer) with five different energy-curable monomers. After mixing, the mixtures were allowed to stand for several hours to ensure stability of the mixtures. The solubility (absence of visible precipitation/separation) is indicated by a “Yes” or “No” in the last line of the table.

TABLE 1
Solubility of Various Chlorinated Polymers in UV/EB Monomers

| | Example No. | | | | | | | | | | | | | | |
|---|---|---|---|---|---|---|---|---|---|---|---|---|---|---|---|
| Components | 1 | 2 | 3 | 4 | 5 | 6 | 7 | 8 | 9 | 10 | 11 | 12 | 13 | 14 | 15 |
| Pergut ® S5 | 2 | 4 | 10 | 2 | 4 | 10 | 2 | 4 | 10 | 2 | 4 | 10 | 2 | 4 | 10 |
| Photomer ® | 98 | 96 | 90 | | | | | | | | | | | | |
| 4035 | | | | | | | | | | | | | | | |
| Photomer ® | | | | 98 | 96 | 90 | | | | | | | | | |
| 4061 | | | | | | | | | | | | | | | |
| Photomer ® | | | | | | | 98 | 96 | 90 | | | | | | |
| 4017 | | | | | | | | | | | | | | | |
| Photomer ® | | | | | | | | | | 98 | 96 | 90 | | | |
| 4149 | | | | | | | | | | | | | | | |
| Photomer ® | | | | | | | | | | | | | 98 | 96 | 90 |
| 4003 | | | | | | | | | | | | | | | |
| Total (wt %) | 100 | 100 | 100 | 100 | 100 | 100 | 100 | 100 | 100 | 100 | 100 | 100 | 100 | 100 | 100 |
| Soluble | Yes | Yes | Yes | Yes | Yes | Yes | Yes | Yes | Yes | No | No | No | No | No | No |
| | Example No. | | | | | | | | | | | | | | |
| Components | 16 | 17 | 18 | 19 | 20 | 21 | 22 | 23 | 24 | 25 | 26 | 27 | 28 | 29 | 30 |
| Pergut ® | 2 | 4 | 10. | 2 | 4 | 10 | 2 | 4 | 10 | 2 | 4 | 10 | 2 | 4 | 10 |
| S20 | | | | | | | | | | | | | | | |
| Photomer ® | 98 | 96 | 90 | | | | | | | | | | | | |
| 4035 | | | | | | | | | | | | | | | |
| Photomer ® | | | | 98 | 96 | 90 | | | | | | | | | |
| 4061 | | | | | | | | | | | | | | | |
| Photomer ® | | | | | | | 98 | 96 | 90 | | | | | | |
| 4017 | | | | | | | | | | | | | | | |
| Photomer ® | | | | | | | | | | 98 | 96 | 90 | | | |
| 4149 | | | | | | | | | | | | | | | |
| Photomer ® | | | | | | | | | | | | | 98 | 96 | 90 |
| 4003 | | | | | | | | | | | | | | | |
| Total (wt %) | 100 | 100 | 100 | 100 | 100 | 100 | 100 | 100 | 100 | 100 | 100 | 100 | 100 | 100 | 100 |
| Soluble | Yes | Yes | Yes | Yes | Yes | Yes | Yes | Yes | Yes | No | No | No | No | No | No |
| | Example No. | | | | | | | | | | | | | | |
| Components | 31 | 32 | 33 | 34 | 35 | 36 | 37 | 38 | 39 | 40 | 41 | 42 | 43 | 44 | 45 |
| Eternal | 2 | 4 | 10 | 2 | 4 | 10 | 2 | 4 | 10 | 2 | 4 | 10 | 2 | 4 | 10 |
| 6314-100 | | | | | | | | | | | | | | | |
| Photomer ® | 98 | 96 | 90 | | | | | | | | | | | | |
| 4035 | | | | | | | | | | | | | | | |
| Photomer ® | | | | 98 | 96 | 90 | | | | | | | | | |
| 4061 | | | | | | | | | | | | | | | |
| Photomer ® | | | | | | | 98 | 96 | 90 | | | | | | |
| 4017 | | | | | | | | | | | | | | | |
| Photomer ® | | | | | | | | | | 98 | 96 | 90 | | | |
| 4149 | | | | | | | | | | | | | | | |
| Photomer ® | | | | | | | | | | | | | 98 | 96 | 90 |
| 4003 | | | | | | | | | | | | | | | |
| Total (wt %) | 100 | 100 | 100 | 100 | 100 | 100 | 100 | 100 | 100 | 100 | 100 | 100 | 100 | 100 | 100 |
| Soluble | Yes | Yes | Yes | Yes | Yes | Yes | Yes | Yes | Yes | Yes | Yes | No | No | No | No |
| | Example No. | | | | | | | | | | | | | | |
| Components | 46 | 47 | 48 | 49 | 50 | 51 | 52 | 53 | 54 | 55 | 56 | 57 | 58 | 59 | 60 |
| CP 164-1 | 2 | 4 | 10 | 2 | 4 | 10 | 2 | 4 | 10 | 2 | 4 | 10 | 2 | 4 | 10 |
| Photomer ® | 98 | 96 | 90 | | | | | | | | | | | | |
| 4035 | | | | | | | | | | | | | | | |
| Photomer ® | | | | 98 | 96 | 90 | | | | | | | | | |
| 4061 | | | | | | | | | | | | | | | |
| Photomer ® | | | | | | | 98 | 96 | 90 | | | | | | |
| 4017 | | | | | | | | | | | | | | | |
| Photomer ® | | | | | | | | | | 98 | 96 | 90 | | | |
| 4149 | | | | | | | | | | | | | | | |
| Photomer ® | | | | | | | | | | | | | 98 | 96 | 90 |
| 4003 | | | | | | | | | | | | | | | |
| Total (wt %) | 100 | 100 | 100 | 100 | 100 | 100 | 100 | 100 | 100 | 100 | 100 | 100 | 100 | 100 | 100 |
| Soluble | No | No | No | No | No | No | No | No | No | No | No | No | No | No | No |

Each of the mixtures which exhibited solubility at concentrations of 10% by weight, namely Examples 3, 6, 9, 18, 21, 24, 33, 36 and 39, were tested for adhesion. A sample of the mixtures was drawn down on a low-surface energy substrate (thermoplastic olefin). Each sample coating was cured by exposure to UV radiation. Adhesion was tested by tape pull. Examples 3, 6, 9, 18, 21 and 24 exhibited excellent adhesion. Examples 33, 36 and 39, which are based on chlorinated polyesters, not chlorinated isoprenes, each exhibited excellent solubility but had poor wetting characteristics and did not show good adhesion.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1-23. (canceled)

24. A free radical, radiation curable coating composition comprising: a solution comprising (a) at least one ethylenically-unsaturated monomer component; and (b) at least one chlorinated polyolefin having a chlorine content of from 50% to 75% by weight of the chlorinated polyolefin, wherein, the at least one chlorinated polyolefin is in solution in the at least one monomer component.

25. The coating composition according to claim 24, wherein the at least one ethylenically-unsaturated monomer component comprises an acrylate.

26. The coating composition according to claim 24, wherein the at least one ethylenically-unsaturated monomer component comprises a polyfunctional acrylate.

27. The coating composition according to claim 24, wherein the at least one ethylenically-unsaturated monomer component comprises a diacrylate.

28. The coating composition according to claim 24, wherein the at least one ethylenically-unsaturated monomer component comprises a linear diacrylate.

29. The coating composition according to claim 24, wherein the at least one ethylenically-unsaturated monomer component comprises 1,6 hexanediol diacrylate.

30. The coating composition according to claim 26, further comprising a monofunctional acrylate adhesion promoter.

31. The coating composition according to claim 30, wherein the promoter is selected from the group consisting of tetrahydrofurfuryl acrylate, N-methyl pyrrolidone acrylate, 2-phenoxyethyl acrylate, 2(2-ethoxyethoxy)ethyl acrylate, isodecyl acrylate, isobornyl acrylate, propoxylated neopentylglycol monomethyl ether acrylate and mixtures thereof.

32. The coating composition according to claim 24, wherein the at least one chlorinated polyolefin comprises a chlorinated polymer prepared by polymerizing and chlorinating at least one component selected from the group consisting of olefin monomers, polyolefin monomers, conjugated diene monomers, diene block homopolymers and diene block copolymers.

33. The coating composition according to claim 24, wherein the at least one chlorinated polyolefin comprises a chlorinated copolymer prepared by polymerizing and chlorinating at least two components selected from the group consisting of olefin monomers, polyolefin monomers, conjugated diene monomers, diene block homopolymers and diene block copolymers.

34. The coating composition according to claim 24, wherein the at least one chlorinated polyolefin comprises a chlorinated polymer prepared by polymerizing and chlorinating a conjugated diene monomer.

35. The coating composition according to claim 24, wherein the at least one chlorinated polyolefin comprises a chlorinated polymer prepared by polymerizing and chlorinating isoprene.

36. The coating composition according to claim 24, wherein the at least one chlorinated polyolefin comprises a chlorinated polymer having one or more ethylenic unsaturations.

37. The coating composition according to claim 24, wherein the at least one chlorinated polyolefin comprises a chlorinated rubber.

38. The coating composition according to claim 37, wherein the chlorinated rubber comprises a chlorinated polyisoprene.

39. The coating composition according to claim 37, wherein the at least one chlorinated polyolefin has a viscosity in toluene at a concentration of 18.5% by weight at room temperature of from about 1 to about 40000 centipoise.

40. The coating composition according to claim 24, wherein the at least one chlorinated polyolefin is in solution at or near its solubility limit in the monomer component.

41. The coating composition according to claim 24, wherein the at least one chlorinated polyolefin has a solubility in the at least one monomer of at least about 5% by weight.

42. A process for coating a substrate, said process comprising:
(a) providing a substrate to be coated;
(b) providing a free radical, radiation curable coating composition comprising: a solution comprising (i) at least one ethylenically-unsaturated monomer component, and (ii) at least one chlorinated polyolefin, wherein the at least one chlorinated polyolefin is in solution in the at least one monomer component;
(c) applying the coating composition to at least a portion of the substrate; and
(d) subjecting at least the coating on the substrate to radiant energy to cure the coating.

43. The process according to claim 42, wherein the substrate comprises a low surface energy plastic.

44. The process according to claim 42, wherein the radiant energy comprises radiation selected from the group consisting of ultraviolet radiation and electron beam radiation.

45. A free radical, radiation curable coating composition comprising: (a) at least one ethylenically-unsaturated monomer component; and (b) at least one chlorinated polyolefin containing from 60% to 75% by weight of chlorine, wherein the at least one chlorinated polyolefin is in solution in the at least one monomer component.

46. A free radical, radiation curable coating composition comprising: a solution comprising (a) 1,6-hexanedioldiacrylate; and (b) a chlorinated rubber compound in solution in an amount of from about 10 to about 25% by weight based on the 1,6-hexanedioldiacrylate, wherein the chlorinated rubber has a chlorine content of at least about 60% by weight based on the chlorinated rubber.
